(19) United States
(12) Patent Application Publication
(10) Pub. No.: US 2026/0177877 A1
(43) Pub. Date: Jun. 25, 2026

(54) CAMERA MODULE WITH TUNABLE LENS

(71) Applicant: Meta Platforms Technologies, LLC, Menlo Park, CA (US)

(72) Inventors: Adar Magen, Sunnyvale, CA (US); Alan Kleiman Shwarsctein, Saratoga, CA (US); Likai Li, Cupertino, CA (US); Changsheng Li, Bellevue, WA (US); Michael Worthington, Tahoe Vista, CA (US); Rebecca Wenjuan Qi, Santa Clara, CA (US)

(21) Appl. No.: 19/390,390

(22) Filed: Nov. 14, 2025

Related U.S. Application Data
(60) Provisional application No. 63/736,516, filed on Dec. 19, 2024.

(51) Int. Cl. G02F 1/29

(52) U.S. Cl. CPC G02F 1/29

(57) ABSTRACT

A camera module includes an image sensor, a lens, and a tunable lens. The lens assists in focusing image light to the image sensor and the tunable lens is configured to modulate an optical power of the tunable lens in response to a signal to focus the image light to the image sensor.

### CROSS-REFERENCE TO RELATED APPLICATIONS

This application claims priority to U.S. provisional Application No. 63/736,516 filed Dec. 19, 2024, which is hereby incorporated by reference.

### TECHNICAL FIELD

This disclosure relates generally to optics, and in particular to camera modules having a tunable lens.

### BACKGROUND INFORMATION

Electronic devices may include one or more cameras. It may be desirable to shrink the camera size for different contexts. Wearables (e.g. head-mount devices) may benefit from a reduced camera size, for example. But, even as the form factor of these devices is reduced, features such as optical zoom and autofocus may be implemented in the camera.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a camera module including Wafer Level Optics (WLOs) disposed between a tunable lens and an image sensor, in accordance with aspects of the disclosure.

FIG. 2 illustrates a camera module including WLOs disposed between a tunable lens and an image sensor, in accordance with aspects of the disclosure.

FIG. 3 illustrates a camera module including a tunable lens disposed between optical elements of WLOs, in accordance with aspects of the disclosure.

FIGS. 4A-4L illustrate an example process flow for fabricating wafer level optics with a tunable lens, in accordance with aspects of the disclosure.

FIGS. 5A-5D illustrate a second option for the first portion of the process flow illustrated in FIGS. 4A-4L, in accordance with aspects of the disclosure.

FIGS. 6A-6G illustrate an example process flow for fabricating a camera module where the tunable lens is disposed between optical elements of the WLOs, in accordance with aspects of the disclosure.

FIG. 7A illustrates a camera module having tunable lens electrodes for providing electrical signals to a tunable lens of the camera module, in accordance with aspects of the disclosure.

FIG. 7B illustrates a side view cross section of camera module that includes tunable lens electrodes providing electrical signals to a tunable lens, in accordance with aspects of the disclosure.

FIG. 8 illustrates a camera module having tunable lens electrodes for providing electrical signals to a tunable lens of a camera module, in accordance with aspects of the disclosure.

FIG. 9 illustrates a camera module having tunable lens electrodes for providing electrical signals to a tunable lens of a camera module, in accordance with aspects of the disclosure.

FIG. 10 illustrates a camera module having tunable lens electrodes for providing electrical signals to a tunable lens of a camera module, in accordance with aspects of the disclosure.

FIG. 11 illustrates a head-mounted device including a camera module that may include aspects of the disclosure.

### DETAILED DESCRIPTION

Embodiments of tunable lenses and wafer level optics in addition to electrostatic discharge mitigation are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Throughout this specification, several terms of art are used. These terms are to take on their ordinary meaning in the art from which they come, unless specifically defined herein or the context of their use would clearly suggest otherwise.

In aspects of this disclosure, visible light may be defined as having a wavelength range of approximately 380 nm-700 nm. Non-visible light may be defined as light having wavelengths that are outside the visible light range, such as ultraviolet light and infrared light. Infrared light having a wavelength range of approximately 700 nm-1 mm includes near-infrared light. In aspects of this disclosure, near-infrared light may be defined as having a wavelength range of approximately 700 nm-1.6 μm.

In aspects of this disclosure, the term “transparent” may be defined as having greater than 90% transmission of light. In some aspects, the term “transparent” may be defined as a material having greater than 90% transmission of visible light.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

Existing camera modules use a large tunable lens to modulate optical power for the camera module. However, these camera modules are large form factor (e.g. 1 inch image sensor) and the tunable lenses are also large being 3×3 mm or 5×5 mm, for example. The tunable lens can be glued on top of a lens barrel assembly of the camera module or be inserted in between the optical elements that are secured by a lens barrel.

In implementations of the disclosure, a tunable lens is integrated with wafer level optics (WLOs) to form a miniaturized camera module. The camera module may be shrunk to approximately 2×2 mm or smaller, for example. In implementations, the camera module is 1×1 mm or smaller. The WLOs may allow the camera to reduce or eliminate a lens barrel to secure the lenses of the camera. The WLOs may support tunable lens rather than a tunable lens being secured to (and supported by) a conventional lens barrel. Without relying on a lens barrel, the WLOs may be coated by an optically opaque material to block outside light from reaching an image sensor that lens(es) of the WLOs are focusing image light to. Electrical traces to drive the tunable lens may be integrated with the WLOs in unique configurations. Using WLOs in camera modules may reduce the size and cost of camera modules while also providing autofocus and image stabilization features to small cameras.

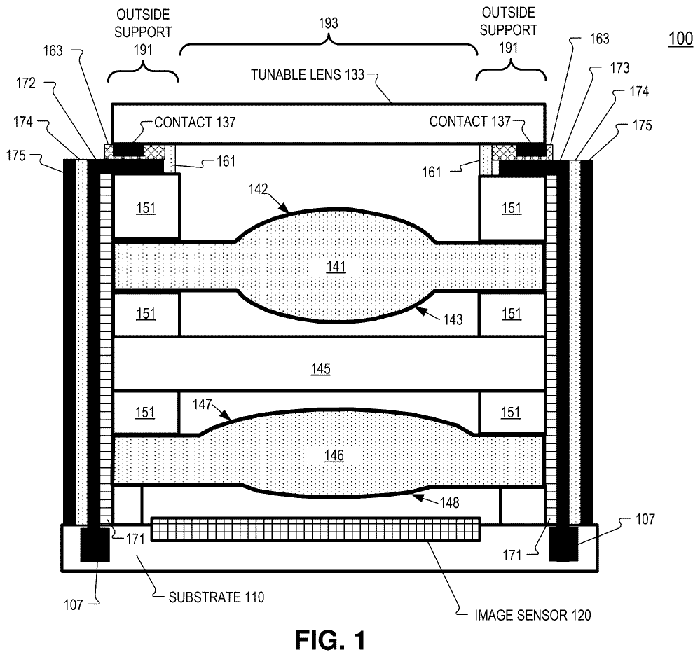

In implementations of the disclosure, a camera module with a tunable lens includes discharge mitigation electrode(s) to mitigate electrostatic discharge (ESD) risks that can compromise the electronics of the camera module. The discharge mitigation electrodes may be disposed alongside tunable lens electrodes that carry a signal to the tunable lens in order to modulate the optical power of the tunable lens. The discharge mitigation electrode(s) may be electrically coupled to a ground of the camera module. The discharge mitigation electrode(s) may be electrically coupled to a cover of the tunable lens. These and other embodiments are described in more detail in connections with FIGS. 1-11.

FIG. 1 illustrates a camera module 100 including Wafer Level Optics (WLOs) disposed between a tunable lens 133 and an image sensor 120, in accordance with aspects of the disclosure. Image sensor 120 is disposed on a substrate 110. Substrate 110 may be a printed circuit board (PCB) or flex circuit, for example. Substrate 110 may carry electrical traces to power image sensor 120 and transmit/receive data to/from image sensor 120.

In FIG. 1, WLOs include optical elements 141, 145, and 146. The optical elements may be refractive lenses, diffractive lenses, and/or filters, for example. Optical element 141 includes optical surface 142 and 143 that may provide lensing power to optical element 141 to focus image light to image sensor 120. Similarly, optical element 146 includes optical surface 147 and 148 that may provide lensing power to optical element 146 to focus the image light to image sensor 120. WLOs can be fabricated on multiple wafers that are then aligned and bonded together before singulating individual WLO assembly stacks. In this way, hundreds (or thousands) of lens assemblies can be fabricated by aligning and bonding wafers and then dicing the wafers. The optical elements of the WLOs may be glass or plastic.

Tunable lens 133 is an optical element which changes its optical power as a function of an applied signal, such as an electric current, voltage, magnetic flux, or other external stimuli. Tunable lens 133 may utilize polymer tunable lens technology or liquid lens technologies, for example. In FIG. 1, tunable lens 133 modulates its optical power in response to an electrical signal. One or more electrical traces 172/173 may carry the signal from substrate 110 to the tunable lens 133.

FIG. 1 illustrates that a conductive material 163 (e.g. conductive glue) may be applied to electrical traces 172/173 near tunable lens 133 to electrically couple the electrical traces 172/173 to electrical contacts 137 of the tunable lens. Additional non-conductive material 161 may be used to adhere tunable lens 133 to spacers 151. Substrate 110 may include bottom contacts 106/107 to electrically couple traces 172/173 to substrate 110. In FIG. 1, electrical traces 172/173 are coupled between tunable lens 133 and substrate 110 to provide an electrical signal to the tunable lens 133 to modulate the optical power of the tunable lens 133. Electrical traces 172/173 may be disposed on an outside perimeter of the wafer level optics that includes lenses such as optical elements 141 and 146.

FIG. 1 illustrates that an optically opaque coating layer 171 may be applied around an outside perimeter of the WLOs to block outside light from reaching image sensor 120 through an outside perimeter of the WLOs. The WLOs may not have a conventional plastic lens barrel around the optical elements so optically opaque coating layer 171 may be required to block out ambient light. Optically opaque coating layer 171 may include a black paint, in some implementations. FIG. 1 also illustrates that an electromagnetic interference (EMI) shield layer 175 may be applied around layers 171 and traces 172/173. EMI shield layer 175 may be electrically coupled to a ground plane (not specifically illustrated) of substrate 110. An insulation layer 174 may be disposed between the EMI shield layer 175 and the electrical traces 172/173 for electrical insulation.

In FIG. 1, at least two lens elements (e.g. 141 and 146) support tunable lens 133 without the presence of a conventional lens barrel to secure the lens elements nor the tunable lens. The optical elements in the WLOs may be supported by another optical element in the WLO and/or spacers 151 that are included in the WLOs. For example, optical element 145 is supported by optical element 146 and spacer(s) 151 and optical element 141 is supported by optical element 146, optical element 145, and spacer(s) 151. In FIG. 1, supported optical elements are supported by an outside support region 191 of the WLOs, whereas inside region 193 of the WLOs is reserved for transmission, filtering, and focusing image light to image sensor 120. Tunable lens 133 is supported by the WLOs, in FIG. 1. In FIG. 1, tunable lens 133 is supported by the outside support region 191 of the WLOs.

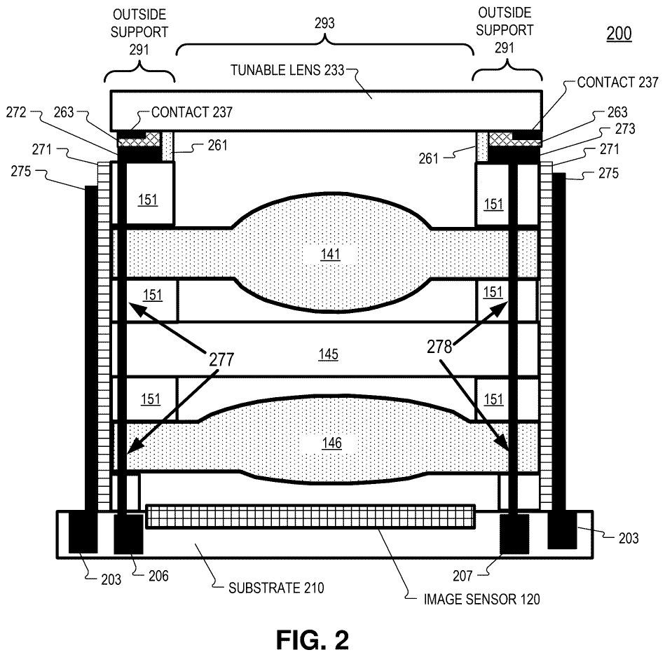

FIG. 2 illustrates a camera module 200 including Wafer Level Optics (WLOs) disposed between a tunable lens 233 and an image sensor 120, in accordance with aspects of the disclosure. FIG. 2 illustrates that electrical traces 271/272 are coupled between the tunable lens 233 and substrate 210 to provide an electrical signal to tunable lens 233 and the electrical traces 271/272 run through Through Wafer Vias (TWVs) 277/278 formed in the wafer level optics. The TWVs 277/288 may include holes running through optical elements 141, 145, 146, and/or spacers 151, for example. Holes in the different wafers may be plated with metal to form the TWVs. The metallization can be done at the wafer level. In an implementation, a conductive adhesive is used to coat the holes in the wafers. In an example, the conductive adhesive is a silver filled epoxy material. The holes may be laser drilled and/or etched, in some implementations. The holes may be laser drilled or etched on a wafer-by-wafer basis and the metallization techniques may be performed before the wafers are combined into stacked wafer level optic assemblies. The holes may also be drilled through spacers 151 so that traces 271/272 can run through the holes.

Image sensor 120 is disposed on a substrate 210, in FIG. 2. Substrate 210 may be a printed circuit board (PCB) or flex circuit, for example. Substrate 210 may carry electrical traces to power image sensor 120 and transmit/receive data to/from image sensor 120.

Camera module 200 has WLOs that include optical elements 141, 145, and 146. The optical elements may be refractive lenses, diffractive lenses, and/or filters, for example. Camera module 200 also includes a tunable lens 233 that may be similar to tunable lens 133. In FIG. 2, tunable lens 233 modulates its optical power in response to an electrical signal. One or more electrical traces 272/273 may carry the signal from substrate 210 to the tunable lens 233.

FIG. 2 illustrates that a conductive material 263 (e.g. conductive glue) may be included at the top of electrical traces 272/273 close to tunable lens 233 to electrically coupled the electrical traces 272/273 to electrical contacts 237 of the tunable lens 233. Additional non-conductive material 261 may be used to adhere tunable lens 233 to spacers 151. Substrate 210 may include bottom contacts 206/207 to electrically couple to traces 272/273. In FIG. 2, electrical traces 272/273 are coupled between tunable lens 233 and substrate 210 (running through the TWVs) to provide an electrical signal to the tunable lens 233 to modulate the optical power of the tunable lens 233.

Electrical traces 272/273 running through TWVs 277 and 278 may run through the wafer level optics on an outside support region 291 of the wafer level optics so that the traces and TWVs do not occlude the lensing and filtering functionality of the optical elements disposed within inside region 293. The outside support region 291 of the wafer level optics are configured to structurally support tunable lens 233. In implementations, at least two lens elements (e.g. 141 and 146) of the wafer level optics are disposed between the outside support portion 291 of the wafer level optics.

FIG. 2 illustrates that an optically opaque coating layer 271 may be applied around an outside perimeter of the WLOs to block outside light from reaching image sensor 120 through an outside perimeter of the WLOs. The WLOs may not have a conventional plastic lens barrel around the optical elements so optically opaque coating layer 271 may be required to block out ambient light. Optically opaque coating layer 271 may include a black paint, in some implementations. FIG. 2 also illustrates that an electromagnetic interference (EMI) shield layer 275 may be applied around layers 271 and traces 272/273. EMI shield layer 275 may be electrically coupled to a ground plane (not specifically illustrated) of substrate 210. Bottom contacts 203 may electrically couple EMI shield layer 275 to the ground plane of substrate 210.

In FIG. 2, at least two lens elements (e.g. 141 and 146) support tunable lens 233 without the presence of a conventional lens barrel to secure the lens elements nor the tunable lens. The optical elements in the WLOs may be supported by another optical element in the WLO and/or spacers 151 that are included in the WLOs. For example, optical element 145 is supported by optical element 146 and spacer(s) 151 and optical element 141 is supported by optical element 146, optical element 145, and spacer(s) 151. In FIG. 2, supported optical elements are supported by an outside support region 291 of the WLOs, whereas inside region 293 of the WLOs is reserved for transmission, filtering, and focusing image light to image sensor 120. Tunable lens 233 is supported by the WLOs, in FIG. 2. In FIG. 2, tunable lens 233 is supported by the outside support region 291 of the WLOs.

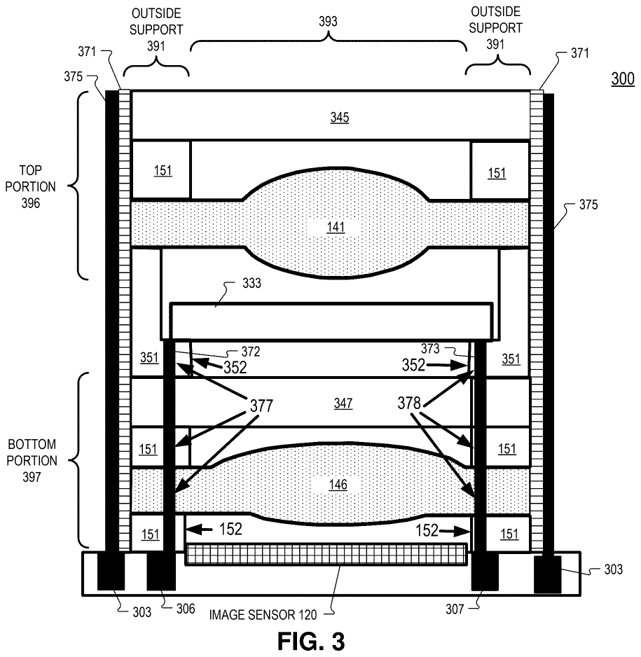

FIG. 3 illustrates a camera module 300 including a tunable lens 333 disposed between optical elements of Wafer Level Optics (WLOs), in accordance with aspects of the disclosure. FIG. 3 illustrates that electrical traces 371/372 are coupled between the tunable lens 333 and substrate 310 to provide an electrical signal to tunable lens 333 and the electrical traces 371/372 run through Through Wafer Vias (TWVs) 377/378 formed in optical elements 146 and 347 of the WLOs. Holes in the different wafers may be plated with metal to form the TWVs. The holes may be laser drilled and/or etched, in some implementations. Positioning tunable lens 333 between optical elements (e.g. optical element 141 and 146) of the WLOs may advantageously protect tunable lens 333 from external contaminants, even as the disposition of the tunable lens 333 creates unique challenges to provide control signals to the tunable lens.

Image sensor 120 is disposed on a substrate 310. Substrate 310 may be a printed circuit board (PCB) or flex circuit, for example. Substrate 310 may carry electrical traces to power image sensor 120 and transmit/receive data to/from image sensor 120.

Camera module 300 also includes a tunable lens 333 that may be similar to tunable lens 133. In FIG. 3, tunable lens 333 modulates its optical power in response to an electrical signal. One or more electrical traces 372/373 may carry the signal from substrate 310 to the tunable lens 333.

Camera module 300 has WLOs that include optical elements 345, 141, 347, and 146. The optical elements may be refractive lenses, diffractive lenses, and/or filters, for example. Tunable lens 333 is disposed between optical elements 146 and 141 in the example illustration, although tunable lens 333 may be disposed between optical elements 141 and 345 or disposed between optical elements 347 and 146, in other implementations.

Electrical traces 372/373 running through TWVs 377 and 378 may run through the wafer level optics on an outside support region 391 of the wafer level optics so that the traces and TWVs don't occlude the lensing and/or filtering functionality of the optical elements disposed within inside region 393. The outside support region 391 of the optical elements 145, 147 and spacers 151 (located below tunable lens 333) are configured to structurally support tunable lens 333. Spacer 351 may support tunable lens 333 in addition to supporting one or more wafer level optics (e.g. 141 and 345) disposed above tunable lens 333. Spacer 351 may have traces 372 and 373 running through TWVs 377/378 of spacer 351.

In some implementations, a portion of the spacers, or all of the spacers, are coated with a light blocking optical coating or a light absorbing optical coating on inner walls 152 and/or 352 of the spacers 151 and/or 351. This optical coating may reduce flare. In some implementations, the optical coating includes a black paint. In some implementations, the optical coating is disposed only on the inner walls of spacers disposed between tunable lens 333 and image sensor 120.

In the illustration of FIG. 3, electrical traces 372/373 run through TWVs 377/378 formed in at bottom portion 397 of the wafer level optics to reach the tunable lens 333. TWVs 377/378 do not extend through a top portion 396 of the wafer level optics where the top portion 396 is defined as above tunable lens 396.

Substrate 310 may include bottom contacts 306/307 to electrically couple to traces 372/373. While camera module 300 shows electrical traces 372/373 running through TWVs 377/378, electrical traces may be run to the perimeter of the WLOs (similar to camera module 100) while tunable lens 333 remains disposed between optical elements of the WLOs, in some implementations.

FIG. 3 illustrates that an optically opaque coating layer 371 may be applied around an outside perimeter of the WLOs to block outside light from reaching image sensor 120 through an outside perimeter of the WLOs. The WLOs may not have a conventional plastic lens barrel around the optical elements so optically opaque coating layer 371 may be required to block out ambient light. Optically opaque coating layer 371 may include a black paint, in some implementations. FIG. 3 also illustrates that an electromagnetic interference (EMI) shield layer 375 may be applied around layers 371 and traces 372/373. EMI shield layer 375 may be electrically coupled to a ground plane (not specifically illustrated) of substrate 310. Bottom contacts 303 may electrically couple EMI shield layer 375 to the ground plane of substrate 310.

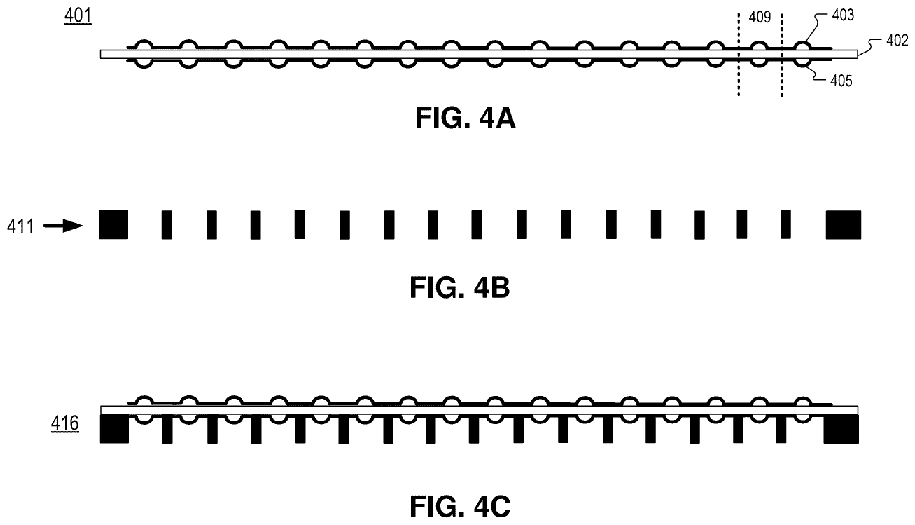

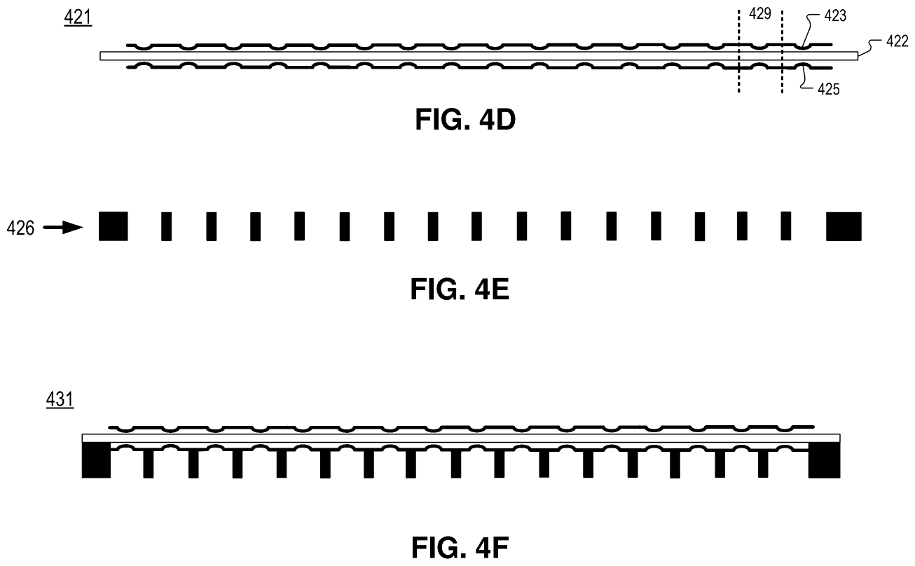

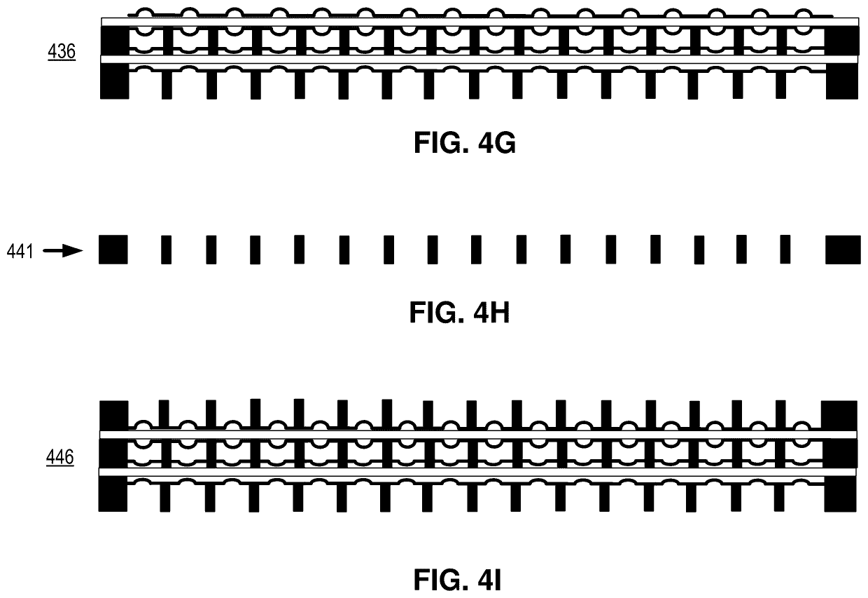

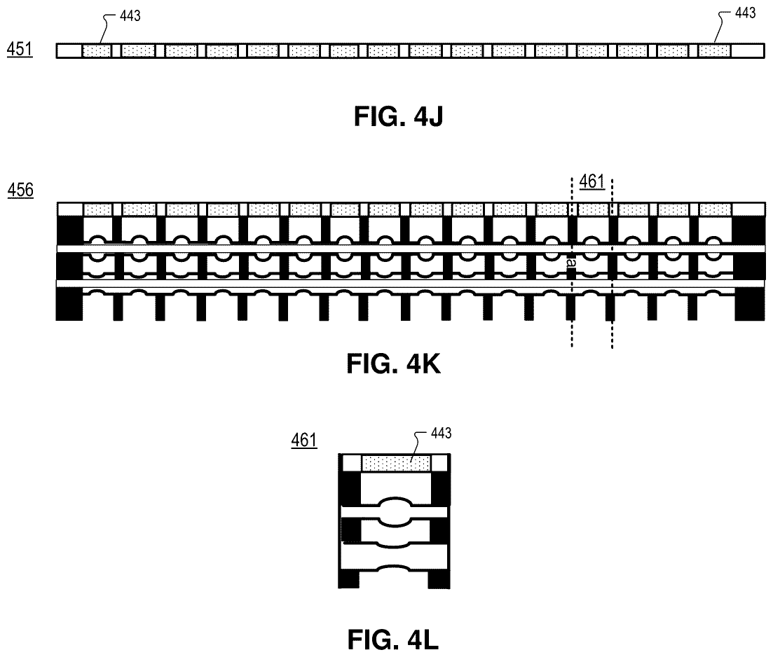

FIGS. 4A-4L illustrate an example process flow for fabricating wafer level optics with a tunable lens, in accordance with aspects of the disclosure. In FIGS. 4A-4L, multiple tunable lenses on the same wafer may be adhered to stacked wafers that include the WLOs. In different implementations, the tunable lens could be positioned in different positions in the optical stack (e.g. between different wafers of optical elements).

FIG. 4A illustrates a first wafer 401 that includes a substrate 402 and optical features 403 and 405. Substrate 402 and optical features 403 and 405 may be a transparent refractive optical material. A curvature of optical feature 403 and 405 may define a lens. First wafer 401 may be singulated into individual optical elements 409 in the future. In some implementations, optical features 403 and/or 405 may be molded with the same material as substrate 402. In some implementations, optical features 403 and/or 405 may be overmolded over a substrate 402 that is made of glass.

FIG. 4B illustrates a spacer structure 411 and FIG. 4C illustrates structure 416 including first wafer 401 being coupled to spacer structure 411. Spacer structure 411 may be adhered to first wafer 401.

FIG. 4D illustrates a second wafer 421 that includes a substrate 422 and optical features 423 and 425. Substrate 422 and optical features 423 and 425 may be a transparent refractive optical material. A curvature of optical feature 423 and 425 may define a lens. Second wafer 421 may be singulated into individual optical elements 429 in the future.

FIG. 4E illustrates a spacer structure 426 and FIG. 4F illustrates structure 431 including second wafer 421 being coupled to spacer structure 426. Spacer structure 426 may be adhered to second wafer 421.

FIG. 4G illustrates a structure 436 including structure 431 from FIG. 4F being coupled to structure 416 from FIG. 4C. Structure 416 may be aligned with and bonded to structure 431 to fabricate structure 436.

FIG. 4H illustrates a spacer structure 441 and FIG. 4I illustrates structure 436 being coupled to spacer structure 441 to form structure 446. Spacer structure 441 may be adhered to structure 436.

FIG. 4J illustrates a tunable lens substrate 451 that includes a plurality of tunable lenses 443. Tunable lens substrate 451 may include a wafer that the structure of the tunable lenses 443 is fabricated on.

FIG. 4K illustrates tunable lens substrate 451 being coupled to structure 446 of FIG. 4I to form structure 456. Structure 456 includes a plurality of wafer level optic assemblies that include a tunable lens 443. Structure 456 may singulated (e.g. diced) to form individual wafer level optic assemblies 461, as shown in FIG. 4L.

Wafer level optic assembly 461 may be used as the wafer level optics and spacers of FIG. 1 and attached to substrate 110 (already including image sensor 120) to form camera module 100, for example. In some implementations, elements 161, 163, 171, and/or 173 are added in fabrication steps to structure 446 of FIG. 4I prior to coupling tunable lens substrate 451 to structure 446. Elements 174 and 175 may be added to wafer level optic assembly 461 after being singulated from structure 456.

Wafer level optic assembly 461 may be used as the wafer level optics and spacers of FIG. 2 and attached to substrate 210 (already including image sensor 120) to form camera module 200, for example. For this implementation, forming the holes and metallization of the holes to form TWV 277 and 278 may be performed individually on every wafer structure on a wafer-by-wafer basis. Forming the holes for the TWV may include an etching process, in some implementations. In some implementations, forming the holes (e.g. laser drilling) through the optical elements and spacers (and adding metallization to the holes to form TWV 277 and 278) of structure 446 of FIG. 4I is performed prior to adding tunable lens substrate 451 to structure 446.

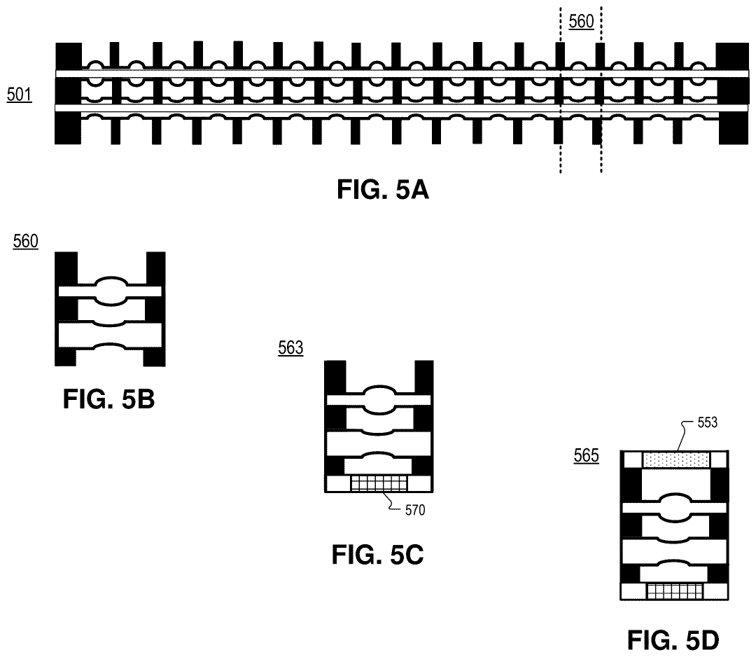

FIGS. 5A-5D illustrate a second option for fabricating the first portion of the process flow illustrated in FIGS. 4A-4L and includes singulating (e.g. dicing) the wafer into individual optical assemblies prior to adding the tunable lens, in accordance with aspects of the disclosure.

FIG. 5A illustrates optical structure 501. Optical structure 501 may use the structure 446 of FIG. 4I. FIG. 5B illustrates an individual optical assembly 560 that was singulated (e.g. by dicing) from optical structure 501. In FIG. 5C, an image sensor 570 (and corresponding substrate such as a PCB) are added to the individual optical assembly 560 to form structure 563. In FIG. 5D, tunable lens 553 is added to structure 563 to form individual wafer level optical assembly 565. Adding the image sensor 570 and the tunable lens 553 to structure 560 may include utilizing Pick and Place techniques.

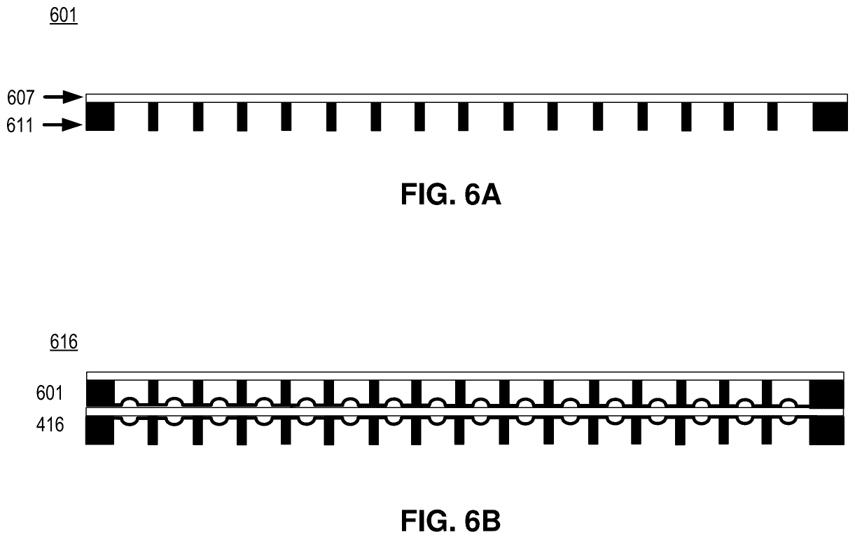

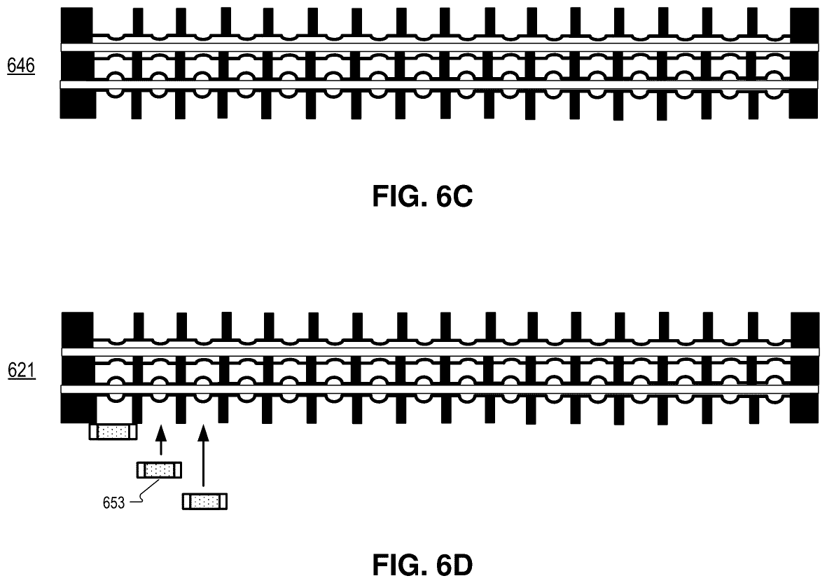

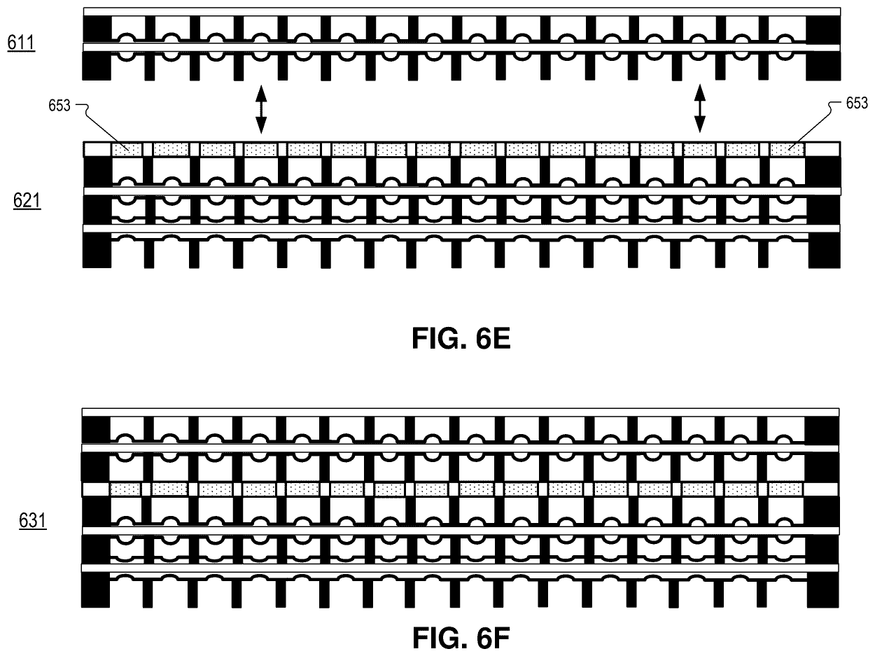

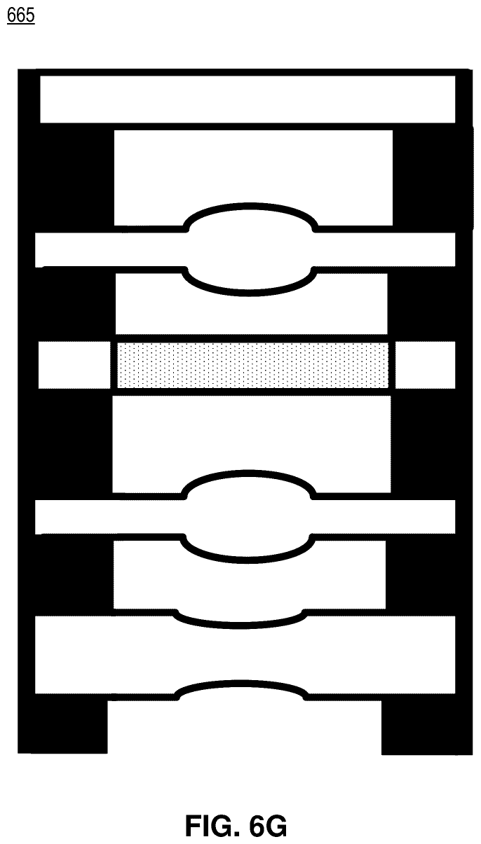

FIGS. 6A-6F illustrate an example process flow for fabricating camera module 300 where the tunable lens is disposed between optical elements of the WLOs, in accordance with aspects of the disclosure.

FIG. 6A illustrates structure 601 including spacer structure 611 coupled to planar structure 607. Spacer structure 611 may be similar to spacer structure 411 in FIG. 4B. Planar structure 607 may be a transparent refractive optical material. Planar structure 607 may include a wafer. Planar structure 607 may include an optical filter.

FIG. 6B illustrates structure 616 that includes structure 601 coupled to structure 416 of FIG. 4C.

FIG. 6C illustrates structure 646 that may be formed similarly to structure 446 of FIG. 4I.

FIG. 6D illustrates forming a structure 621 by adding standalone tunable lenses 653 to structure 646 of FIG. 6C. Tunable lenses 653 may be added to structure 646 using Pick-and-Place techniques, for example.

FIG. 6E illustrates bringing together structure 611 from FIG. 6B and structure 621 from structure 6D.

FIG. 6F illustrates structure 631 after the combination of structures 611 and 621. Notably, tunable lenses 653 are disposed between different optical elements that are wafer level optics of structure 631.

FIG. 6G illustrates an individual wafer level optical assembly 665 after being singulated from the structure 631 of FIG. 6F.

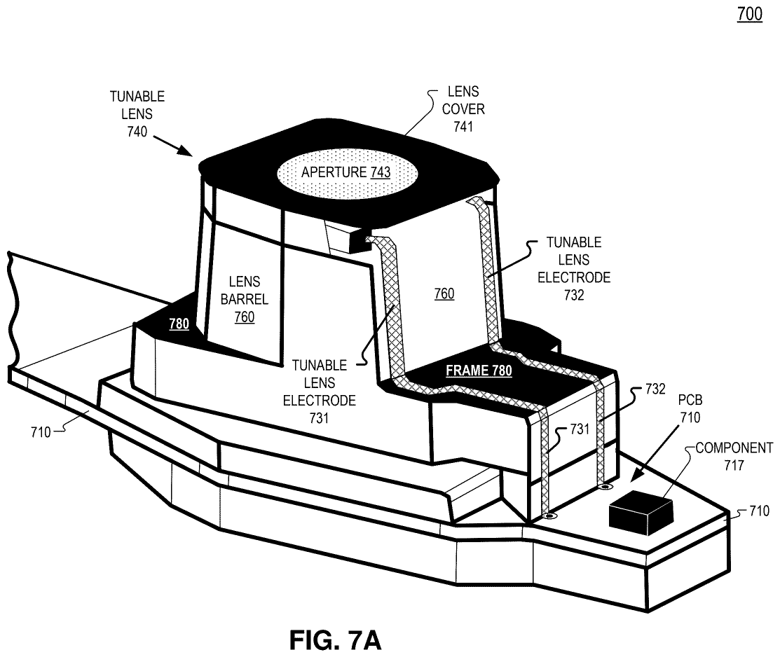

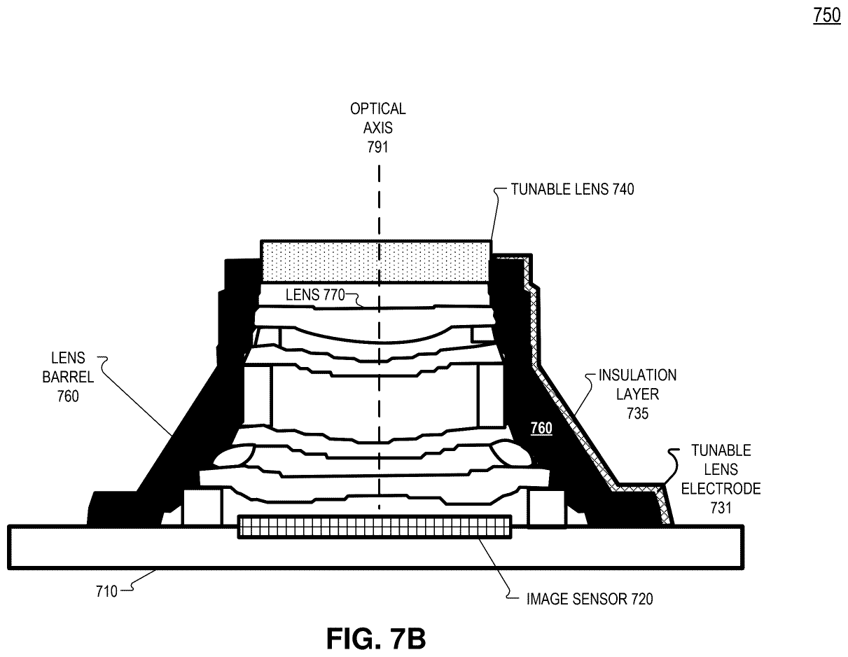

FIG. 7A illustrates a camera module 700 having tunable lens electrodes for providing electrical signals to a tunable lens of the camera module, in accordance with aspects of the disclosure. Camera module 700 includes an image sensor (not particularly illustrated in FIG. 7A) disposed on a substrate 710. In FIG. 7A, the substrate is shown as a PCB. The substrate may also be a flexible circuit. In addition to an image sensor, other electrical components (e.g. electrical component 717) may be disposed on the substrate 710. The electrical components may include resistors, capacitors, transistors, power supplies, or otherwise.

Camera module 700 includes a lens barrel 760 configured to hold one or more lenses and/or filters to focus image light to the image sensor. The lens(es) or filters secured by the lens barrel 760 are disposed between tunable lens 740 and the image sensor. Tunable lens 740 includes a lens cover 741 and an aperture 743 to receive image light. The tunable lens 740 is configured to modulate an optical power of the tunable lens in response to a signal to focus image light to the image sensor. Camera module 700 may include a frame 780 that supports and/or retains the lens barrel 760. Frame 780 may be secured to the substrate 710. Frame 780 may be electrically coupled to a ground of substrate 710. In FIG. 7, tunable lens electrodes 731 and 732 are disposed on lens barrel 760 to carry the electrical signal (that modulates the optical power of tunable lens 740) from substrate 710 to tunable lens 740. Tunable lens electrodes 731 and 732 may be electrically coupled to electrical contacts of tunable lens 740.

FIG. 7B illustrates a side view cross section of camera module 750 that includes tunable lens electrode 731 providing electrical signals to a tunable lens 740, in accordance with aspects of the disclosure. Lens barrel 760 is configured to hold the lenses (e.g. lens 770) and tunable lens 740 in optical series with each other within the lens barrel 760. Tunable lens 740 and the lenses held by lens barrel 760 may be centered around a same optical axis 791. Tunable lens 740 and the lenses held by lens barrel 760 may be rotationally symmetric around optical axis 791. FIG. 7B shows that an insulation layer 735 may be applied over tunable electrode 731 to electrically insulate electrode 731 from the outside environment.

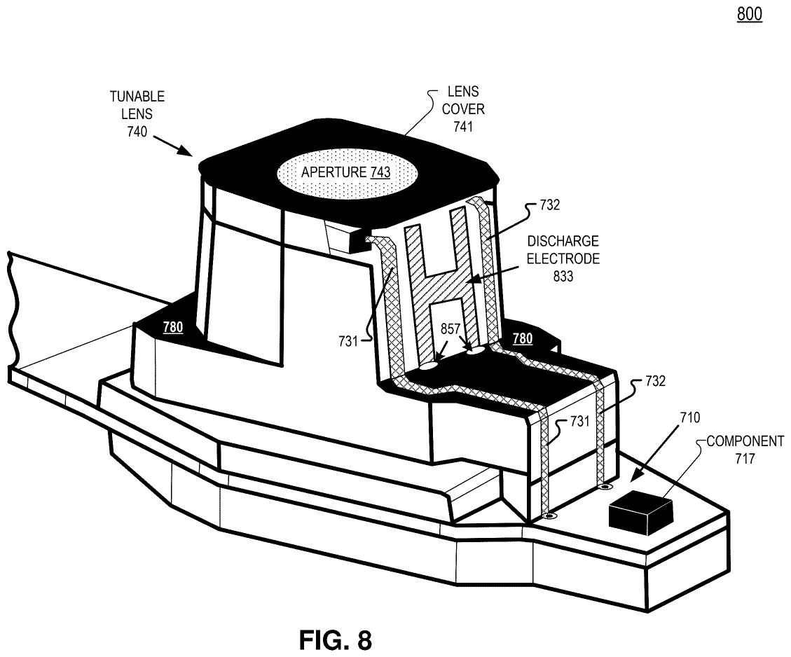

FIG. 8 illustrates a camera module 800 having tunable lens electrodes 731 and 732 for providing electrical signals to tunable lens 740 of camera module 800, in accordance with aspects of the disclosure. Camera module 800 includes an image sensor (not particularly illustrated in FIG. 8) disposed on a substrate 710. Camera module 800 may add exposed discharge mitigation electrodes 833 to camera module 700. Exposed discharge mitigation electrode 833 is disposed alongside the tunable lens electrodes 731 and 732 and configured to short any electrostatic discharge to a system ground of the camera module 800. Exposed discharge mitigation electrode 833 function to short electrostatic discharge to an electrical ground to reduce electronic failure due to ESD during handling, fabrication, or use, for example. For camera module 800, discharge mitigation electrode 833 is shaped like an “H.” Discharge mitigation electrode 833 runs approximately parallel to the tunable lens electrodes 731 and 732, in FIG. 8. Being disposed close to electrodes 731 and 732, discharge mitigation electrode 833 is positioned to receive any ESD that may usually be directed to electrodes 731 and 732. An electrical insulation layer over electrode 731 and 732 may further steer any ESD toward the exposed discharge mitigation electrode 833. The electrical insulation layer over electrode 731 and 732 may be similar to insulation layer 735 in FIG. 7B. The electrical insulation layer over electrode 731 and 732 may be an insulation paint.

Exposed discharge mitigation electrode 833 is coupled to a system ground of camera module 800 by way of a conductive glue 857 that electrically couples the discharge mitigation electrode 833 to conductive frame 780. Conductive frame 780 may be a metal frame that is electrically coupled to an electrical ground of substrate 710. Conductive frame 780 may include magnesium.

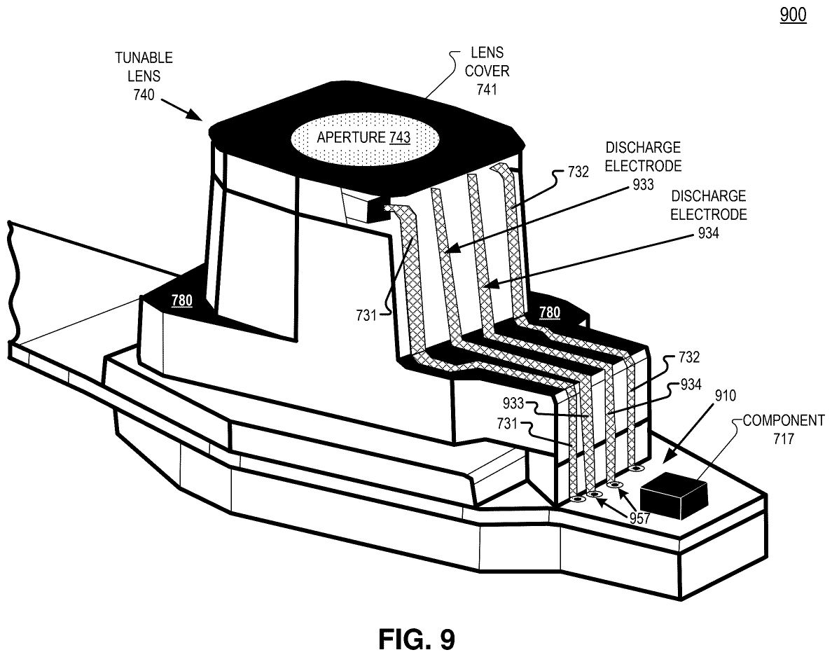

FIG. 9 illustrates a camera module 900 having tunable lens electrodes 731 and 732 for providing electrical signals to tunable lens 740 of camera module 900, in accordance with aspects of the disclosure. Camera module 900 includes an image sensor (not particularly illustrated in FIG. 9) disposed on a substrate 710. Camera module 900 includes discharge mitigation electrodes 933 and 934. Exposed discharge mitigation electrodes 933 and 934 are disposed alongside the tunable lens electrodes 731 and 732 and configured to short any electrostatic discharge to a system ground of the camera module 900. Exposed discharge mitigation electrodes 933 and 934 function to short electrostatic discharge to an electrical ground to reduce electronic failure due to ESD during handling, fabrication, or use, for example.

For camera module 900, discharge mitigation electrodes 933 and 934 run approximately parallel to the tunable lens electrodes 731 and 732, respectively. Discharge mitigation electrodes 933 and 934 run from a ground of substrate 910 to just short of the tunable lens 740. In particular in FIG. 9, discharge mitigation electrodes 933 and 934 run just short of lens cover 741. Discharge mitigation electrodes 933 and 934 may be electrically coupled to electrical pads 957 (e.g. copper pads) of substrate 910. An electrical insulation layer over electrode 731 and 732 may further steer any ESD toward the exposed discharge mitigation electrodes 933 and 934. The electrical insulation layer over electrode 731 and 732 may be similar to insulation layer 735 in FIG. 7B. The electrical insulation layer over electrode 731 and 732 may be an insulation paint.

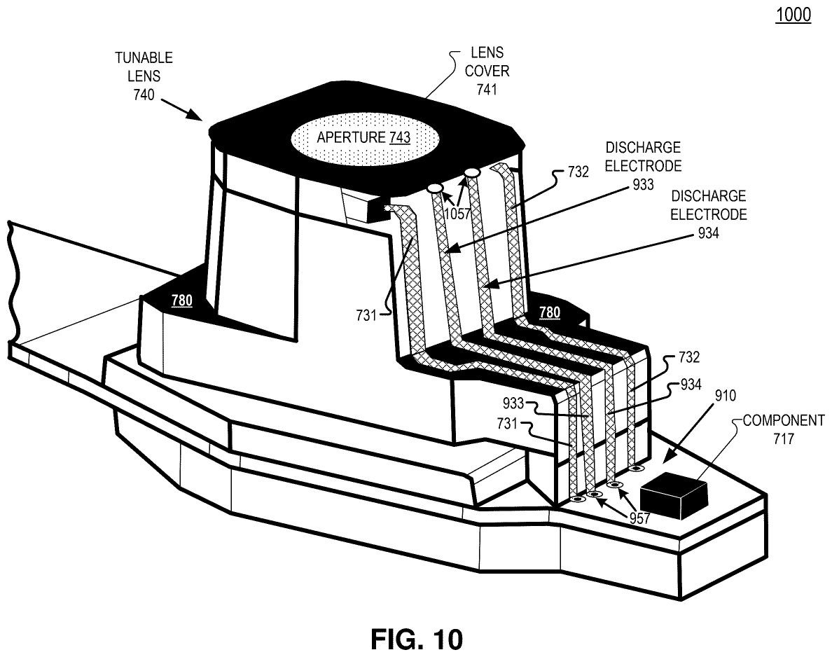

FIG. 10 illustrates a camera module 1000 having tunable lens electrodes 731 and 732 for providing electrical signals to tunable lens 740 of camera module 1000, in accordance with aspects of the disclosure. Camera module 1000 includes an image sensor (not particularly illustrated in FIG. 10) disposed on a substrate 710. Camera module 1000 includes discharge mitigation electrodes 933 and 934. Exposed discharge mitigation electrodes 933 and 934 are disposed alongside the tunable lens electrodes 731 and 732 and configured to short any electrostatic discharge to a system ground of the camera module 1000. Exposed discharge mitigation electrodes 933 and 934 function to short electrostatic discharge to an electrical ground to reduce electronic failure due to ESD during handling, fabrication, or use, for example.

Discharge mitigation electrodes 933 and 934 run from a ground of substrate 910 to an electrically conductive cover 741 of tunable lens 740. In FIG. 10, discharge mitigation electrodes 933 and 934 run just short of lens cover 741. Discharge mitigation electrodes 933 and 934 are electrically coupled to electrical pads 957 and electrically coupled to conductive cover 741 by way conductive glue 1057. Lens cover 741 may be generally covered with a dielectric material to provide electrical insulation from the outside environment for the conductive cover 741. However, a void or voids in the dielectric coating over lens cover 741 may be formed to electrically couple electrodes 933 and 934 with lens cover 741. This electrical coupling extends the ESD protection of camera module 1000 to include lens cover 741 so that if ESD breaks through a dielectric coating of lens cover 741, the discharge is shorted to a system ground to protect other electronic components from the discharge.

An electrical insulation layer over electrode 731 and 732 may further steer any ESD toward the exposed discharge mitigation electrodes 933 and 934. The electrical insulation layer over electrode 731 and 732 may be similar to insulation layer 735 in FIG. 7B. The electrical insulation layer over electrode 731 and 732 may be an insulation paint.

In aspects of the disclosure, lens barrel 760 includes plastic and the exposed discharge mitigation electrodes are a Laser Direct Structuring (LDS) electrode formed on the plastic of the lens barrel 760. The material used for LDS can include copper/nickel/palladium/gold or copper/nickel/gold however other metal layers can be used consistent with the specific application. In some implementations, traces may be fabricated by adding a conductive material or conductive ink by or a combination of know materials and technologies including pad, screen printing, ink jet printing, jetting/dispensing, electro/electroless plating.

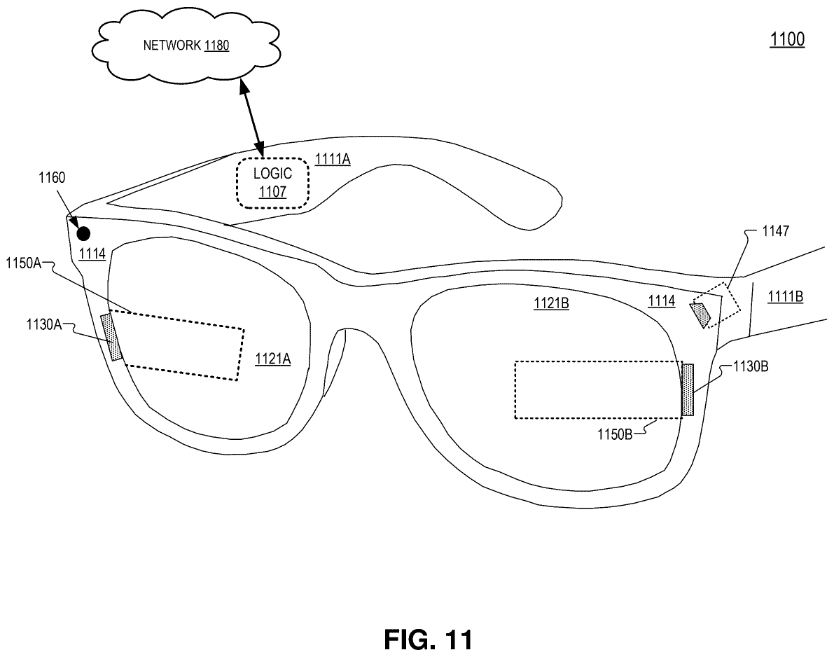

FIG. 11 illustrates a head mounted display (HMD) 1100 that may include a camera module 1160 that includes aspects of the disclosure. HMD 1100 includes frame 1114 coupled to arms 1111A and 1111B. Lens assemblies 1121A and 1121B are mounted to frame 1114. Lens assemblies 1121A and 1121B may include a prescription lens matched to a particular user of HMD 1100. The illustrated HMD 1100 is configured to be worn on or about a head of a wearer of HMD 1100.

Camera 1160 may be included in frame 1114 or arms 1111 of a head-mounted device such as HMD 1100. Camera 1160 may be considered a forward-facing camera. Aspects of camera modules 100, 200, 300, 700, 750, 800, and/or 900 may be implemented in camera 1160 in HMD 1100 or other wearable device, for example. Camera 1160 may include a complementary metal-oxide semiconductor (CMOS) image sensor.

In the HMD 1100 illustrated in FIG. 11, each lens assembly 1121A/1121B includes a waveguide 1150A/1150B to direct image light generated by displays 1130A/1130B to an eyebox area for viewing by a user of HMD 1100. Displays 1130A/1130B may include a beam-scanning display or a liquid crystal on silicon (LCOS) display for directing image light to a wearer of HMD 1100 to present virtual images, for example.

Lens assemblies 1121A and 1121B may appear transparent to a user to facilitate augmented reality or mixed reality to enable a user to view scene light from the environment around them while also receiving image light directed to their eye(s) by, for example, waveguides 1150. Lens assemblies 1121A and 1121B may include two or more optical layers for different functionalities such as display, eye-tracking, and optical power. In some embodiments, image light from display 1130A or 1130B is only directed into one eye of the wearer of HMD 1100. In an embodiment, both displays 1130A and 1130B are used to direct image light into waveguides 1150A and 1150B, respectively. The implementations of the disclosure may also be used in head mounted devices (e.g. smartglasses) that don't necessarily include a display but are configured to be worn on or about a head of a wearer.

Frame 1114 and arms 1111 may include supporting hardware of HMD 1100 such as processing logic 1107, a wired and/or wireless data interface for sending and receiving data, graphic processors, and one or more memories for storing data and computer-executable instructions. Processing logic 1107 may include circuitry, logic, instructions stored in a machine-readable storage medium, ASIC circuitry, FPGA circuitry, and/or one or more processors. In one embodiment, HMD 1100 may be configured to receive wired power. In one embodiment, HMD 1100 is configured to be powered by one or more batteries. In one embodiment, HMD 1100 may be configured to receive wired data including video data via a wired communication channel. In one embodiment, HMD 1100 is configured to receive wireless data including video data via a wireless communication channel. Processing logic 1107 may be communicatively coupled to a network 1180 to provide data to network 1180 and/or access data within network 1180. The communication channel between processing logic 1107 and network 1180 may be wired or wireless.

In the illustrated implementation of FIG. 11, HMD 1100 includes a camera 1147 configured to image an eyebox region. In some implementations, an illumination module may illuminate the eyebox region with near-infrared illumination light to assist camera 1147 in imaging the eyebox region for eye-tracking purposes. Camera 1147 may include a lens assembly configured to focus image light to a complementary metal-oxide semiconductor (CMOS) image sensor, in some implementations. A near-infrared filter that receives a narrow-band near-infrared wavelength may be placed over the image sensor so it is sensitive to the narrow-band near-infrared wavelength while rejecting visible light and wavelengths outside the narrow-band.

The term “processing logic” (e.g. 1107) in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

Networks may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, short-range wireless protocols, SPI (Serial Peripheral Interface), I2C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A camera module comprising:
an image sensor disposed on a substrate;
wafer level optics including at least two lens elements configured to focus image light to the image sensor; and
a tunable lens configured to modulate an optical power of the tunable lens in response to a signal, wherein the wafer level optics are disposed between the tunable lens and the image sensor.

2. The camera module of claim 1, wherein the at least two lens elements of the wafer level optics support the tunable lens without a lens barrel supporting the tunable lens nor supporting the wafer level optics.

3. The camera module of claim 2 further comprising:
an optically opaque coating layer disposed around the wafer level optics to block outside light from reaching the image sensor through an outside perimeter of the wafer level optics.

4. The camera module of claim 1 further comprising:
electrical traces coupled between the tunable lens and the substrate to provide the signal to the tunable lens, wherein the electrical traces are disposed on a perimeter of the wafer level optics.

5. The camera module of claim 1 further comprising:
electrical traces coupled between the tunable lens and the substrate to provide the signal to the tunable lens, wherein the electrical traces run through Through Wafer Vias (TWV) formed in the wafer level optics.

6. The camera module of claim 5, wherein the electrical traces run through an outside support portion of the wafer level optics, the outside support portion of the wafer level optics configured to structurally support the tunable lens, wherein the at least two lens elements of the wafer level optics are disposed between the outside support portion of the wafer level optics.

7. The camera module of claim 6 further comprising:
an insulating layer configured to electrically insulate the electrical traces; and
an electromagnetic interference (EMI) shielding layer, wherein the insulating layer is disposed between the EMI shielding layer and the electrical traces.

8. The camera module of claim 1, wherein the tunable lens and the wafer level optics are singulated from an array optical modules that include a plurality of tunable lenses coupled to wafer level optics.

9. A camera module comprising:
an image sensor disposed on a substrate;
wafer level optics configured to focus image light to the image sensor; and
a tunable lens configured to modulate an optical power of the tunable lens in response to a signal, wherein the tunable lens is disposed between optical elements of the wafer level optics.

10. The camera module of claim 9 further comprising:
electrical traces coupled between the tunable lens and the substrate to provide the signal to the tunable lens, wherein the electrical traces run through Through Wafer Vias (TWV) formed in at bottom portion of the wafer level optics to reach the tunable lens disposed between the optical elements, wherein the TWV does not extend through a top portion of the wafer level optics.

11. The camera module of claim 10, wherein the electrical traces run through an outside support portion of the bottom portion of the wafer level optics to reach the tunable lens disposed between the optical elements of the wafer level optics, the outside support portion of the wafer level optics configured to structurally support the tunable lens disposed between the optical elements of the wafer level optics.

12. The camera module of claim 11, wherein the optical elements of the wafer level optics support the tunable lens without a lens barrel supporting the tunable lens nor supporting the wafer level optics.

13. The camera module of claim 12 further comprising:
an optically opaque coating layer disposed around the wafer level optics to block outside light from reaching the image sensor through an outside perimeter of the wafer level optics.

14. A camera module comprising:
an image sensor disposed on a substrate;
a tunable lens configured to modulate an optical power of the tunable lens in response to a signal, wherein the tunable lens is configured to focus image light to the image sensor;
a lens disposed between the tunable lens and the image sensor;
a lens barrel configured to hold the lens and the tunable lens in optical series with each other within the lens barrel;
tunable lens electrodes disposed on the lens barrel and configured to carry the signal from the substrate to the tunable lens; and
an exposed discharge mitigation electrode disposed alongside the tunable lens electrodes and configured to short an electrostatic discharge to a system ground of the camera module.

15. The camera module of claim 14, wherein the exposed discharge mitigation electrode is coupled to a system ground of the camera module by way of a conductive glue that electrically couples the discharge mitigation electrode to a conductive frame of the camera module.

16. The camera module of claim 14, wherein the exposed discharge mitigation electrode runs from a ground of the substrate to just short of the tunable lens.

17. The camera module of claim 14, wherein the exposed discharge mitigation electrode runs from a ground of the substrate to an electrically conductive cover of the tunable lens.

18. The camera module of claim 14, wherein the exposed discharge mitigation electrode runs approximately parallel to the tunable lens electrodes.

19. The camera module of claim 14, wherein the lens barrel includes plastic, and wherein the exposed discharge mitigation electrode is a Laser Direct Structuring (LDS) electrode formed on the plastic of the lens barrel.

20. The camera module of claim 14, wherein the tunable lens electrodes are insulated by an insulation layer.
